(19) United States
(12) Patent Application Publication
(10) Pub. No.: US 2014/0229895 A1
(43) Pub. Date: Aug. 14, 2014

(54) INFORMATION PROCESSING DEVICE, INFORMATION PROCESSING METHOD AND COMPUTER PROGRAM

(71) Applicants: Takuro Noda, Tokyo (JP); Ikuo Yamano, Tokyo (JP); Hiroyuki Mizunuma, Tokyo (JP)

(72) Inventors: Takuro Noda, Tokyo (JP); Ikuo Yamano, Tokyo (JP); Hiroyuki Mizunuma, Tokyo (JP)

(73) Assignee: SONY CORPORATION, Tokyo (JP)

(21) Appl. No.: 14/347,376

(22) PCT Filed: Aug. 27, 2012
(86) PCT No.: PCT/JP2012/005346

§ 371 Date: Mar. 26, 2014

(30) Foreign Application Priority Data
Oct. 4, 2011 (JP) 2011-219947

(51) Int. Cl. G06F 3/0485; G06F 3/0482

(52) U.S. Cl. CPC G06F 3/0485; G06F 3/0482
USPC 715/830

(57) ABSTRACT

An information processing device may include a control unit to control display, on a first surface of a display unit, of a plurality of objects to be operated by a user, where the first surface is opposite a second surface including a detection area. The control unit, in response to a tap manipulation to a position of the second surface, may control scrolling of the objects.

### CROSS-REFERENCE TO RELATED APPLICATIONS

This application claims priority from Japanese Patent Application No. 2011-219947 filed in the Japan Patent Office on Oct. 4, 2011, the entire contents of which is hereby incorporated by reference.

### TECHNICAL FIELD

The present disclosure relates to an information processing device, an information processing method and a computer program, and more specifically, to an information processing device, an information processing method and a computer program that detect a manipulation input of an input object using a touch sensor.

### BACKGROUND ART

There is an input device using a sensor, such as a touch panel, as a controller for a GUI (Graphical User Interface) widely used as a smart phone, a tablet terminal or the like.

In an input device of the related art, a sensor is mainly provided in only a surface on which a display unit is provided. However, in such an input device, a manipulation input is performed from the surface, such that information displayed on the display unit is hidden by a finger, which deteriorates operability. In recent years, as resolution in a display unit has become higher, operability is considered to be further deteriorated. Further, an input manipulation from the surface is easily seen by others and, for example, when highly confidential information such as a password number is input, it is difficult to hide the input information. Further, with the recent increase in touch manipulation variations, operations (gestures) upon input manipulation conflict such that malfunction easily occurs and the operability is deteriorated.

In recent years, touch panels capable of simultaneously detecting contacts of a plurality of fingers, that is, so-called multi-touch, have also begun to spread. Further, as a plurality of sensors is included in a device, improvement of operability has been realized (e.g., JP 2010-108061A and JP 2009-157908A JP 2009-157908A). In such a device, as one touch sensor is provided in an opposite surface (a back surface) of a display unit of the device to detect contact of a finger, a manipulation input can be performed on a side of the back surface, and a display screen is not hidden by a finger even when the device is small. Further, intuitive interaction or expansion of a manipulation system, which has not been realized in a touch panel with a plurality of sensors in related art, can be realized.

### SUMMARY

### Technical Problem

However, when a sensor is arranged in a back surface that it is difficult for a user to see and recognize in use, a manipulation to designate a position with an absolute coordinate is difficult, such as a manipulation to touch a specific button displayed on a display surface or an input of letters. Because of this, it is effective for such a sensor to be used to detect an intuitive manipulation input such as gesture.

Here, a case in which a touch pad is arranged as a sensor in a position that is difficult for a user to see in use and a drag manipulation is performed as a manipulation input is considered. When a movable range of a finger is narrow, a drag manipulation with only finger motion applies a large load to the finger even when the manipulation is an intuitive manipulation. It is preferable to provide a device that is easily manipulated with a reduced finger manipulation load when an intuitive manipulation input is performed.

### Solution to Problem

In accordance with one embodiment, an information processing device may include a control unit to control display, on a first surface of a display unit, of a plurality of objects to be operated by a user, where the first surface is opposite a second surface including a detection area. The control unit, in response to a tap manipulation to a position of the second surface, controls scrolling of the objects.

In accordance with another embodiment, an information processing method may include controlling, by a processor, display, on a first surface of a display unit, of a plurality of objects to be operated by a user, where the first surface is opposite a second surface including a detection area. The method further may include, in response to a tap manipulation to a position of the second surface, controlling scrolling of the objects.

In accordance with another embodiment, a non-transitory recording medium may be recorded with a program executable by a computer. The program may include controlling display, on a first surface of a display unit, of a plurality of objects to be operated by a user, where the first surface is opposite a second surface including a detection area. The program may further include, in response to a tap manipulation to a position of the second surface, controlling scrolling of the objects.

### Advantageous Effects of Invention

As described above, according to the present disclosure, it is possible to provide an information processing device, an information processing method, and a computer program capable of reducing a finger manipulation load when an intuitive manipulation input is performed.

### BRIEF DESCRIPTION OF DRAWINGS

FIG. 1 is a schematic perspective view showing a configuration of an information terminal in which a user performs a scroll manipulation according to an embodiment of the present disclosure.

FIG. 2 is a diagram illustrating an overview of a scroll manipulation provided by the information processing device according to the embodiment.

FIG. 3 is a functional block diagram showing a functional configuration of the information processing device according to the embodiment.

FIG. 4 is a flowchart showing a scroll process by a tap manipulation according to the embodiment.

FIG. 5 is an illustrative diagram showing a relationship between a touch point and a release point in a general tap manipulation determination process.

FIG. 6 is a diagram illustrating a method of determining a scroll direction and a scroll manipulation amount by a tap manipulation.

FIG. 7 is a block diagram showing a hardware configuration example of the information processing device according to the embodiment.

### DESCRIPTION OF EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Further, a description will be given in the following order.

### 1. Overview of Scroll Manipulation

### 2. Configuration of Information Processing Device

### 3. Scroll Process by Tap Manipulation

### 4. Hardware Configuration Example

### <1. Overview of Scroll Manipulation>

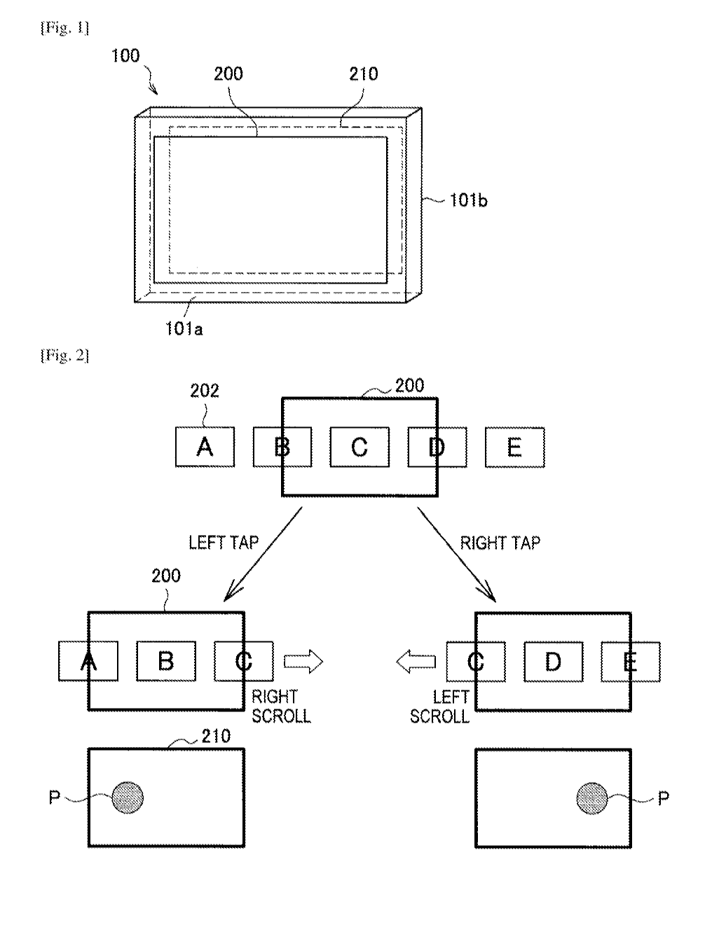

First, an overview of a scroll manipulation in an embodiment of the present disclosure will be described with reference to FIGS. 1 and 2. Further, FIG. 1 is a schematic perspective view showing a configuration of an information terminal in which a user performs a scroll manipulation. FIG. 2 is an illustrative diagram illustrating an overview of a scroll manipulation provided by the information processing device according to the present embodiment.

The information processing device according to the present embodiment is a device in which a manipulation target displayed on a display unit of an information terminal is manipulated based on a position in which a user has performed a tap manipulation. As the information processing device is used, for example, feed of a list of thumbnails, icons and the like of photographs, videos or documents, fast forward/rewind of videos, volume up and down, and the like displayed on the display unit, which have been generally performed by a drag manipulation, can be performed by the tap manipulation.

For example, as shown in FIG. 1, a display unit 200 is provided on a surface 101a of an information terminal 100, and a back touch sensor 210 is arranged in an opposite surface 101b of the surface 101a. The back touch sensor 210 is arranged in a position that is difficult for a user to see upon manipulation. When contact of an input object with the back surface 101b of the information terminal 100 is detected by the back touch sensor 210, the information processing device issues an event to manipulate the manipulation target displayed on the display unit 200.

A manipulation on the back surface 101b is generally performed with a finger that can freely move while holding the information terminal 100. Because of this, a movable range of the finger is narrow and a manipulation load easily increases. In such a case, it is necessary to make a manipulation possible by holding the information terminal 100 by the other hand or moving an entire hand, which consumes time. The information processing device of the information terminal 100 according to the present embodiment enables the scroll manipulation that is usually performed by a drag manipulation to be performed by a tap manipulation in order to reduce a manipulation load.

For example, as shown in FIG. 2, a list of five photographs 202 “A” to “E” arranged in a line is assumed to be displayed on the display unit 200. In this case, when the information processing device according to the present embodiment senses that a tap manipulation is performed on a left side of the detection area of the back touch sensor 210, the information processing device scrolls the list of photographs 202 displayed on the display unit 200 to the right. On the other hand, when the information processing device senses that the tap manipulation is performed on a right side of the detection area of the back touch sensor 210, the information processing device scrolls the list of photographs 202 displayed on the display unit 200 to the left. Thus, as the list is scrolled according to the position in which the tap manipulation has been performed, it is possible to greatly reduce a manipulation load of a user in comparison with a case in which the drag manipulation is repeatedly performed to scroll the list.

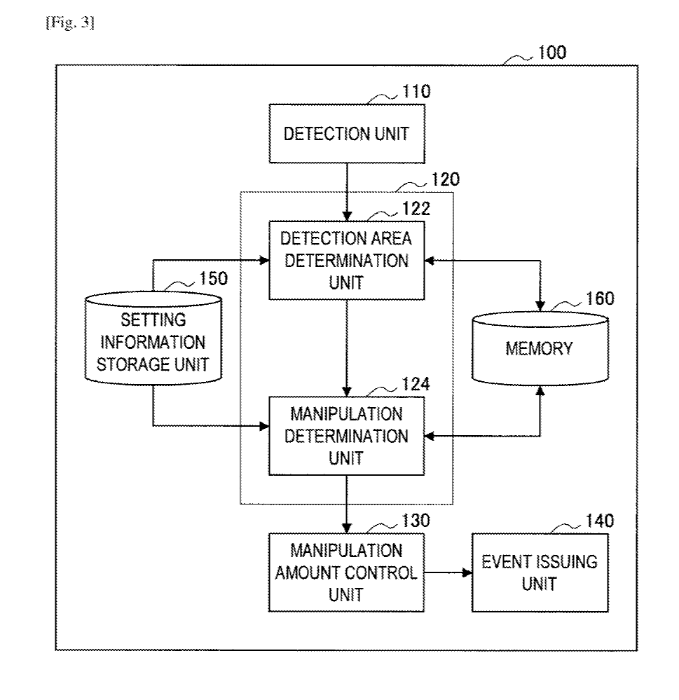

Hereinafter, a configuration of the information processing device of the information terminal 100 according to the present embodiment and a scroll process by the tap manipulation in such a configuration will be described in detail with reference to FIGS. 3 to 7.

### <2. Configuration of Information Processing Device>

FIG. 3 shows a functional configuration of an information processing device of an information terminal 100 according to the present embodiment. The information processing device includes a detection unit 110, a determination processing unit 120, a manipulation amount control unit 130, an event issuing unit 140, a setting information storage unit 150, and a memory 160, as shown in FIG. 3.

The detection unit 110 is one of input devices used by a user to input information, and detects contact of an input object such as a finger. For example, an electrostatic touch panel in which contact of an input object is detected by sensing an electrical signal resulting from static electricity, a pressure-sensitive touch panel in which a change in pressure applied to a back surface is sensed to detect contact of a finger, or the like may be used as the detection unit 110. When the detection unit 110 detects contact of the input object, the detection unit 110 outputs a detection ID, position information p0(x0, y0), and a contact time t0 assigned to specify the contact of the input object, as a detection signal, to the determination processing unit 120.

The determination processing unit 120 is a processing unit for analyzing a motion of the input object to determine whether a tap manipulation is performed. The determination processing unit 120 includes a detection area determination unit 122 and a manipulation determination unit 124.

The detection area determination unit 122 determines whether the input object contacts the contact detection surface based on the position information of the detection signal from the detection unit 110. The detection area determination unit 122 acquires a range of the detection area 210 of the detection unit 110 provided to correspond the contact detection surface by referring to the setting information storage unit 150. Also, the detection area determination unit 122 determines whether the contact position of the input object is included in the detection area 210 based on the position information of the detection signal.

Here, a contact determination area used for a determination on the contact of the input object, which is a portion of the detection area 210, may be set for the detection area 210. The contact determination area is an area of the detection area 210 other than a position that the input object of the user is highly like to unintentionally contact. As the contact of the input object is determined using such a contact determination area, it possible to prevent a wrong determination in which the tap manipulation is determined to have been performed in opposition to the user's intension.

When the detection area determination unit 122 determines that the contact position of the input object is included in the detection area 210 or in the contact determination area, the detection area determination unit 122 instructs the manipulation determination unit 124 to continuously monitor the detection signal for the detection ID assigned to the contact operation of the input object. In this case, the detection area determination unit 122 records the information contained in the detection signal received from the detection unit 110, that is, the detection ID, the position information and the contact time, in the memory 150.

The manipulation determination unit 124 determines a manipulation input performed by the user from a motion of the input object contacting the detection area 210 or the contact determination area. The manipulation determination unit 124, for example, monitors the motion of the input object and determines whether the tap manipulation is performed based on a tap manipulation determination process that will be described later. Also, when it is determined that the tap manipulation has been performed, the manipulation determination unit 124 instructs the manipulation amount control unit 130 to calculate a manipulation amount to scroll the manipulation target. Further, when the manipulation determination unit 124 determines that the touch manipulation has not been performed, the manipulation determination unit 124 does not instruct the manipulation amount control unit 130 to calculate the manipulation amount.

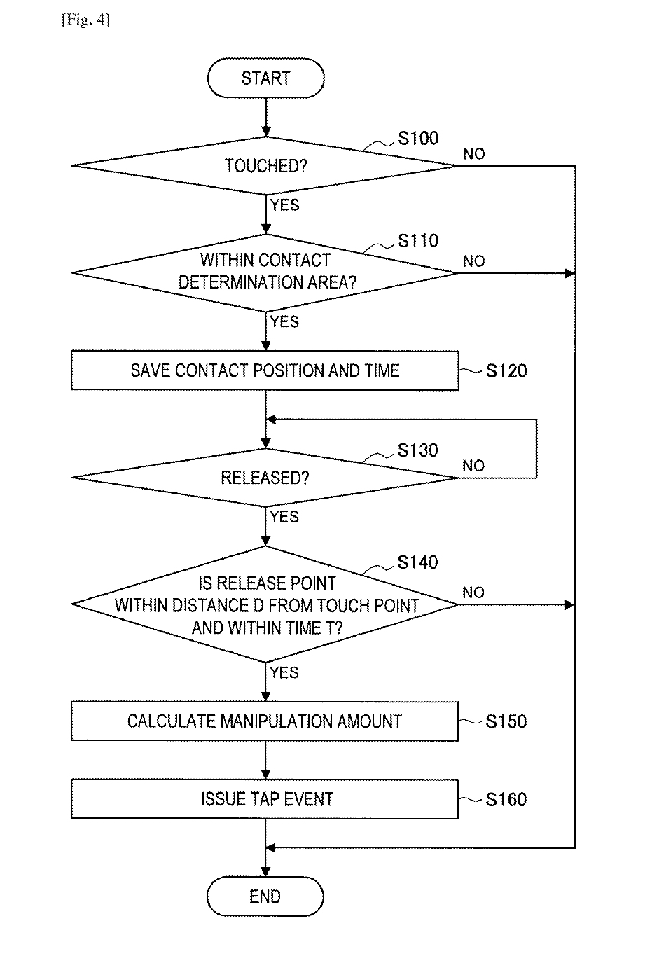

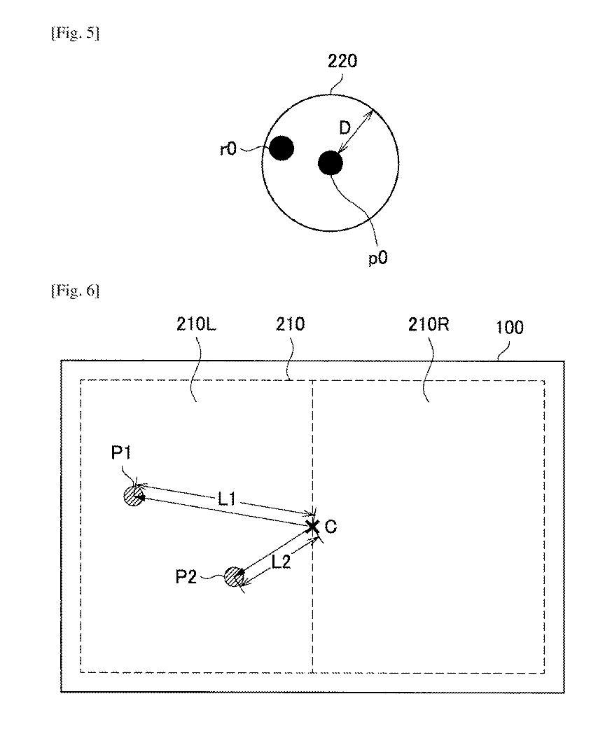

Details of the tap manipulation determination process in the manipulation processing unit 120 will be described in detail with reference to FIGS. 4 and 5 later.

The manipulation amount control unit 130 calculates a manipulation amount of the manipulation target based on a contact position in which the tap manipulation has been performed. The manipulation amount control unit 130, for example, calculates a manipulation amount according to the contact position each time so that the manipulation amount increases as the contact position of the input object is separated from the center of the detection area. The manipulation control unit 130 outputs the calculated manipulation amount together with an event issuance indication executed by the touch manipulation to the event issuing unit 140. Further, the manipulation amount control unit 130 may function only when the manipulation amount of the input object is changed according to a distance between the contact position of the input object performing the tap manipulation and the center of the detection area.

The event issuing unit 140 issues an event based on the indication from the manipulation amount control unit 130. In the present embodiment, the event issuing unit 140 receives the manipulation amount and the event issuance indication from the manipulation amount control unit 130, and issues an event associated with the tap manipulation, that is, an event of the manipulation target scroll process.

The setting information storage unit 150 stores various setting information necessary for the tap manipulation determination process or the manipulation target scroll manipulation. For example, area information indicating the range of the detection area of the detection unit 110 or a tap determination distance D and a tap determination time T for determination of the tap manipulation are recorded in the setting information storage unit 150. The information may be stored in the setting information storage unit 150 in advance or may be appropriately set and stored by the user.

The memory 160 is a storage unit for temporarily storing information necessary for the tap manipulation determination process. For example, the information contained in the detection signal received from the detection unit 110 is recorded in the memory 160.

### 3. Scroll Process by Tap Manipulation>

The information processing device performs a scroll process by a tap manipulation according to a flowchart shown in FIG. 4. Here, the detection unit 110 is assumed to continuously monitor whether there is the contact of the input object with the contact detection surface (S100). The detection unit 110 iteratively performs the process of step S100 until the detection unit 110 detects the contact of the input object with the contact detection surface. Also, if the detection unit 110 detects the contact of the input object with the contact detection surface, the detection unit 110 outputs a detection signal to the detection area determination unit 122.

When the detection area determination unit 122 receives the detection signal from the detection unit 110, the detection area determination unit 122 determines whether a contact position of the input object with the contact detection surface is in the detection area 210 or in the contact determination area (S110). In the present embodiment, the contact of the input object is assumed to be determined using the contact determination area. As described above, the contact determination area is a portion of the detection area 210 of the detection unit 110, and may be set to exclude an area of the detection area 210 that a finger of a user is highly likely to unintentionally contact. When the detection area determination unit 122 determines that the contact position of the input object is not in the contact determination area, the detection area determination unit 122 ends the process shown in FIG. 4 and repeatedly performs the process from step S100. That is, through the process in step S110, even when the input object of the user unintentionally contacts the detection area 210 excluded from the contact determination area, the contact of the input object is neglected. Thus, it is possible to reduce possibility of a wrong event being issued.

Meanwhile, if it is determined in step S110 that there is the contact position of the input object in the contact determination area, the detection area determination unit 122 records a contact position and a contact time of the input object in association with a detection ID in the memory 160 (S120). Also, the manipulation determination unit 124 continues to monitor the detection signal for the detection ID and determines whether the input object is separated (released) from the contact detection surface (S130). The process of step S130 is repeated until the input object release is detected.

When the release of the input object is detected in step S130, the manipulation determination unit 124 determines whether a tap manipulation is performed based on a distance between the contact position of the input object and the separated position, and a time between the contact of the input object with the contact detection surface and the separation (S140).

Here, a general tap manipulation determination process will be described with reference to FIG. 5. FIG. 5 is an illustrative diagram showing a relationship between a touch point and a release point in a general tap manipulation determination process. When the touch sensor detects the contact of the input object with the contact detection surface, the touch sensor outputs a detection signal indicating a contact state of the input object to the information processing device. A detection ID that is unique information assigned to specify the contact of the input object, position information p0(x0, y0) indicating the contact position of the input object on the contact detection surface, and a contact time t0 are contained in the detection signal. The information processing device records each piece of information of the detection signal received from the touch sensor in the memory 160.

The information processing device continuously monitors the detection signal for the detection ID assigned to the input object contacting the contact detection surface. Also, when the input object is moved a predetermined distance (a tap determination distance) D or more from the contact position p0, the information processing device determines that the input object does not perform the tap manipulation and stops monitoring the detection signal of the detection ID. Meanwhile, when the input object is separated from the contact detection surface, the information processing device determines that a series of motions performed by the input object is the tap manipulation when the movement distance from the contact position p0 is smaller than the tap determination distance D and a contact time between the contact of the input object with the contact detection surface and the separation is less than a predetermined time (a tap determination time) T. That is, when the input object is separated from the contact detection surface within a tap determination time T in a circular tap determination area 220 of a radius D having the touch point p0 shown in FIG. 5 as a center, the information processing device determines the manipulation to be the tap manipulation.

The process of step S140 in FIG. 4 is performed using such a tap manipulation determination process. In the present embodiment, the manipulation determination unit 124 calculates a movement distance and a contact time from the detection signal when the input object has contacted the contact detection surface and the detection signal when the input object release has been detected, which are stored in the memory 160. Also, the manipulation determination unit 124 acquires the tap determination distance D and the tap determination time T from the setting information storage unit 140 and compares them with the calculated movement distance and the calculated contact time.

When the condition that the movement distance of the input object be smaller than the tap determination distance D and the contact time of the input object be less than the tap determination time T is not satisfied, the manipulation determination unit 124 ends the process shown in FIG. 4 and iteratively performs the process from step S100. On the other hand, when the movement distance of the input object is smaller than the tap determination distance D and the contact time of the input object is less than the tap determination time T, the manipulation determination unit 124 determines that the tap manipulation has been performed and determines issuance of an event corresponding to the tap manipulation.

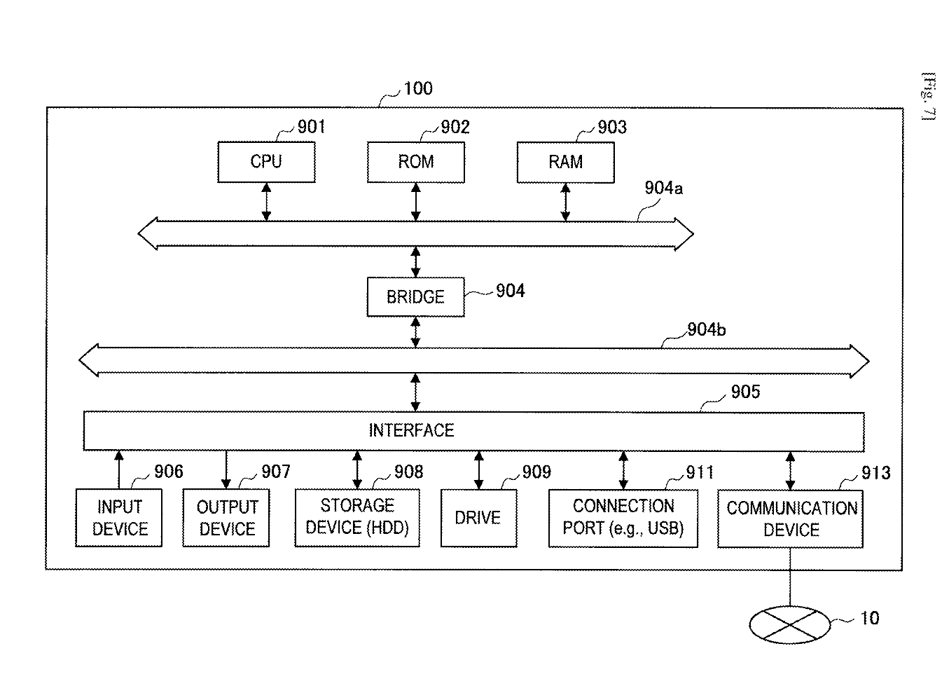

When the issuance of the event is determined, a manipulation amount of the manipulation target is calculated by the manipulation amount control unit 130 (S150). For example, a back touch sensor 210 is assumed to be provided in the information terminal 100, as shown in FIG. 6. A detection area of the back touch sensor 210 includes a right area 210R located on a right side of a paper surface from a center C of the detection area, which is a boundary, and a left area 210L located on a left side of the paper surface. For example, in the example shown in FIG. 2, when the tap manipulation in the right area 210R in step S140 is detected, the list of the photographs 202 that is the manipulation target displayed on the display unit is scrolled in a left direction. On the other hand, when the tap manipulation in the left area 210L is detected, the list of the photographs 202 that is the manipulation target displayed on the display unit is scrolled in a right direction.

In addition to the scroll direction determined in step S140, the manipulation amount control unit 130 determines a scroll manipulation amount based on the distance between the contact position of the input object and the center C of the detection area of the back touch sensor 210. For example, it is assumed that there are a contact position P1 close to an outer periphery of the detection area, and a contact position P2 close to the center C of the detection area, as shown in FIG. 6. A distance between the contact position P1 and the center C is L1, and a distance between the contact position P2 and the center C is L2 (<L1). In this case, the manipulation amount control unit 130 can increase the manipulation amount as the contact position is separated from the center C of the detection area.

In FIG. 6, since the contact position P1 rather than the contact position P2 is separated from the center C of the detection area, a manipulation amount of a list scroll manipulation by the tap manipulation in the contact position P1 is greater than that in the contact position P2. That is, a scroll amount by one tap manipulation in the contact position P1 is larger than a scroll amount by one tap manipulation in the contact position P2. Thus, as a manipulation amount of the manipulation target can be changed according to positions in which the tap manipulation is performed, the operability can be further enhanced. For an increase in a manipulation amount according to a distance from the center C of the detection area to the contact position of the input object, for example, the manipulation amount may increase in proportion to the distance or acceleratively.

When a manipulation amount to scroll the manipulation target is calculated by the manipulation amount control unit 130, the event issuing unit 140 issues an event to scroll the manipulation target based on the tap manipulation (S160). In this case, the event issuing unit 140 scrolls the manipulation target by the manipulation amount calculated from the distance from the center C of the detection area to the contact position in a scroll direction determined from the contact position of the input object with respect to the center C of the detection area.

A manipulation target scroll process by a tap manipulation according to the present embodiment has been described above. Thus, the scroll process that is usually performed by a drag manipulation can be performed by the tap manipulation. Accordingly, the user can easily scroll the manipulation target without holding the terminal in the other hand or moving an entire hand even with a finger whose movable range is narrowed because it holds the information terminal 100, thereby reducing a manipulation load of the user.

Here, as described above, it is possible to scroll the manipulation target only with the tap manipulation, but a normal drag manipulation and the tap manipulation may both be allocated to the scroll process such that the two manipulations can also coexist. In this case, the manipulations can be distinguished. For example, when the scroll manipulation amount is desired to be finely controlled, the drag manipulation is used, and when the manipulation target is desired to be greatly scrolled, tap manipulation is used.

Further, in the above-described example, when the left area 210L of the detection area is tapped, the manipulation target is scrolled to the right, and when the right area 210R of the detection area is tapped, the manipulation target is scrolled to the left, but the present technology is not limited to such an example. A relationship between the position of the tap manipulation and the scroll direction of the manipulation target can be set according to a shape of a screen or a user's preference. Accordingly, for example, when the right area 210R of the detection area is tapped, the manipulation target may be scrolled to the right, and when the left area 210L of the detection area is tapped, the manipulation target may be scrolled to the left. Further, when the manipulation target is desired to be scrolled in a vertical direction of the screen, for example, the manipulation target may be scrolled downward when an upper area of the detection area is tapped, and the manipulation target may be scrolled upward when a lower area is tapped. It is understood that the relationship the position of the tap manipulation and the scroll direction of the manipulation target may be reversed.

Further, a determination as to whether the scroll direction is a horizontal direction or a vertical direction may be automatically made by the manipulation determination unit 124 according to a list structure of the manipulation target displayed on the display unit 200. Further, even when a direction of the information terminal 100 is changed and the list structure is dynamically changed according to the direction of the screen, the relationship between the contact position by the tap manipulation and the scroll direction may be changed according to the change in the list structure.

Further, when the manipulation target has a two-dimensional structure such as a map, a manipulation target can be moved on a plane according to a position in which the tap manipulation has been performed.

Further, when a sensor is provided in a position that is difficult for a user to see upon manipulation like the back touch sensor 210 of the present embodiment, it is possible to increase operability by providing a notification unit for performing feedback to a user in response to a manipulation. The feedback includes, for example, visual feedback, for example, to fluctuate display information displayed on the display unit 200 when a manipulation is performed or create a ripple in a position in which the tap manipulation has been performed. Alternatively, acoustical feedback may be performed. For example, sound may be output when a manipulation is performed.

### (Exemplary Hardware Configuration)

A process of the information processing device in accordance with this embodiment can be executed either by hardware or software. In this case, the information processing device can be configured as shown in FIG. 7. Hereinafter, an exemplary hardware configuration of the information processing device in accordance with this embodiment will be described with reference to FIG. 7.

The information processing device in accordance with this embodiment can be implemented by a processing device such as a computer as described above. As shown in FIG. 7, the information processing device includes a CPU (Central Processing Unit) 901, ROM (Read Only Memory) 902, RAM (Random Access Memory) 903, and a host bus 904a. In addition, the information processing device also includes a bridge 904, an external bus 904b, an interface 905, an input device 906, an output device 907, a storage device (HDD) 908, a drive 909, a connection port 911, and a communication device 913.

The CPU 901 functions as an arithmetic processing unit and a control unit, and controls the entire operation within the information processing device in accordance with various programs. The CPU 901 may also be a microprocessor. The ROM 902 stores programs, operation parameters, and the like used by the CPU 901. The RAM 903 temporarily stores programs used in the execution of the CPU 901, parameters that change as appropriate during the execution, and the like. These units are mutually connected via the host bus 904a including a CPU bus or the like.

The host bus 904a is connected to the external bus 904b such as a PCI (Peripheral Component Interconnect/Interface) bus via the bridge 904. Note that the host bus 904a, the bridge 904, and the external bus 904b need not necessarily be arranged separately, and the functions of such components may be integrated into a single bus.

The input device 906 includes an input means for a user to input information, such as a mouse, a keyboard, a touch panel, a button, a microphone, a switch, or a lever; an input control circuit that generates an input signal on the basis of a user input and outputs the signal to the CPU 901; and the like. The output device 907 includes a display device such as, for example, a liquid crystal display (LCD) device, an OLED (Organic Light Emitting Diode) device, or a lamp; and an audio output device such as a speaker.

The storage device 908 is a device for storing data, constructed as an example of a storage unit of the information processing device. The storage device 908 can include a storage medium, a recording device that records data on the storage medium, a reading device that reads data from the storage medium, a deletion device that deletes data recorded on the storage medium, and the like. The storage device 908 includes, for example, a HDD (Hard Disk Drive). The storage device 908 stores programs and various data for driving the hard disk and executed by the CPU 901.

The drive 909 is a reader/writer for a storage medium, and is incorporated in or externally attached to the information processing device. The drive 909 reads information recorded on a removable storage medium such as a magnetic disk, an optical disc, a magnetooptical disk, or semiconductor memory that is mounted, and outputs the information to the RAM 903.

The communication port 911 is an interface for connection to an external device, and is, for example, a connection port for connection to an external device that can transmit data via a USB (Universal Serial Bus). The communication device 913 is, for example, a communication interface including a communication device and the like for connection to the communication network 10. The communication device 913 may be any of a communication device supporting a wireless LAN (Local Area Network), a communication device supporting a wireless USB, or a wire communication device that performs wire communication.

Although the preferred embodiments of the present disclosure have been described in detail with reference to the appended drawings, the present disclosure is not limited thereto. It is obvious to those skilled in the art that various modifications or variations are possible insofar as they are within the technical scope of the appended claims or the equivalents thereof. It should be understood that such modifications or variations are also within the technical scope of the present disclosure.

For example, in the above embodiments, the example in which the touch sensor is provided as a detection unit on the back surface of the terminal has been described. However, the present technology is not limited to such an example. For example, the tap manipulation determination process in the information processing device of the present technology may be applied to a touch sensor provided on a surface or a side of the terminal.

Moreover, embodiments of the present technology are not limited to those described above, and various modifications can be made within the scope of the preset technology.

Additionally, the present technology may also be configured as below.

(1) An information processing device comprising:

a control unit to control display, on a first surface of a display unit, of a plurality of objects to be operated by a user, the first surface being opposite a second surface including a detection area,

wherein, in response to a tap manipulation to a position of the second surface, the control unit controls scrolling of the objects.

(2) The device according to (1), wherein the control unit determines a direction of the scrolling based on a position of the second surface at which the tap manipulation is performed.
(3) The device according to (1), where the control unit controls an amount of manipulation of the objects as a manipulation target according to a relationship between a center of the detection area and the position of the detection area at which the tap manipulation is performed.
(4) The device according to (3), wherein the amount of manipulation is increased as a distance between the center of the detection area and the position of the detection area at which the tap manipulation is performed is increased.
(5) The device according to (1), wherein the control unit notifies as feedback when the tap manipulation is performed.
(6) The device according to (1), wherein the control unit:

determines a movement distance of an input object from a contact position to a separated position on the detection area and a contact time between contact of the input object with and separation of the input object from the detection area based on a detection signal, and

determines that a motion of the input object is a tap manipulation when the movement distance is less than a predetermined distance and the contact time is less than a predetermined time.

(7) The device according to (1), wherein the control unit determines whether a tap manipulation is performed based on a contact time between contact of an input object with and separation of the input object from the detection area based on a detection signal.
(8) The device according to (1), wherein the control unit determines whether a tap manipulation is performed based on a determination of contact of an input object with a contact determination area which is a portion of the detection area.
(9) The device according to (1), wherein, when an object of the plurality of objects as a manipulation target has a two-dimensional structure, the manipulation target is scrollable on a plane according to the position at which the tap manipulation is performed.
(10) The device according to (9), wherein the manipulation target having the two-dimensional structure is a map.
(11) The device according to (1), wherein the objects are images arranged in a line.
(12) The device according to (11), wherein, in response to the tap manipulation, the control unit controls scrolling of the images from a first side of the first surface to a second side of the first surface, the second side being opposite the first side.
(13) An information processing method comprising:

controlling, by a processor, display, on a first surface of a display unit, of a plurality of objects to be operated by a user, the first surface being opposite a second surface including a detection area, and

in response to a tap manipulation to a position of the second surface, controlling scrolling of the objects.

(14) A non-transitory recording medium recorded with a program executable by a computer, the program comprising:

controlling display, on a first surface of a display unit, of a plurality of objects to be operated by a user, the first surface being opposite a second surface including a detection area, and

in response to a tap manipulation to a position of the second surface, controlling scrolling of the objects.

### REFERENCE SIGNS LIST

100 Information processing device
110 Detection unit
120 Determination processing unit
122 Detection area determination unit
124 Manipulation determination unit
130 Manipulation amount control unit
140 Event issuing unit
150 Setting information storage unit
160 Memory
200 Display unit
210 Detection area
220 Tap determination area

1. An information processing device comprising:
a control unit to control display, on a first surface of a display unit, of a plurality of objects to be operated by a user, the first surface being opposite a second surface including a detection area,
wherein, in response to a tap manipulation to a position of the second surface, the control unit controls scrolling of the objects.

2. The device of claim 1, wherein the control unit determines a direction of the scrolling based on a position of the second surface at which the tap manipulation is performed.

3. The device of claim 1, where the control unit controls an amount of manipulation of the objects as a manipulation target according to a relationship between a center of the detection area and the position of the detection area at which the tap manipulation is performed.

4. The device of claim 3, wherein the amount of manipulation is increased as a distance between the center of the detection area and the position of the detection area at which the tap manipulation is performed is increased.

5. The device of claim 1, wherein the control unit notifies as feedback when the tap manipulation is performed.

6. The device of claim 1, wherein the control unit:
determines a movement distance of an input object from a contact position to a separated position on the detection area and a contact time between contact of the input object with and separation of the input object from the detection area based on a detection signal, and
determines that a motion of the input object is a tap manipulation when the movement distance is less than a predetermined distance and the contact time is less than a predetermined time.

7. The device of claim 1, wherein the control unit determines whether a tap manipulation is performed based on a contact time between contact of an input object with and separation of the input object from the detection area based on a detection signal.

8. The device of claim 1, wherein the control unit determines whether a tap manipulation is performed based on a determination of contact of an input object with a contact determination area which is a portion of the detection area.

9. The device of claim 1, wherein, when an object of the plurality of objects as a manipulation target has a two-dimensional structure, the manipulation target is scrollable on a plane according to the position at which the tap manipulation is performed.

10. The device of claim 9, wherein the manipulation target having the two-dimensional structure is a map.

11. The device of claim 1, wherein the objects are images arranged in a line.

12. The device of claim 11, wherein, in response to the tap manipulation, the control unit controls scrolling of the images from a first side of the first surface to a second side of the first surface, the second side being opposite the first side.

13. An information processing method comprising:
controlling, by a processor, display, on a first surface of a display unit, of a plurality of objects to be operated by a user, the first surface being opposite a second surface including a detection area, and
in response to a tap manipulation to a position of the second surface, controlling scrolling of the objects.

14. A non-transitory recording medium recorded with a program executable by a computer, the program comprising:
controlling display, on a first surface of a display unit, of a plurality of objects to be operated by a user, the first surface being opposite a second surface including a detection area, and
in response to a tap manipulation to a position of the second surface, controlling scrolling of the objects.
